(19) United States
(12) Patent Application Publication
(10) Pub. No.: US 2021/0323884 A1
(43) Pub. Date: Oct. 21, 2021

(54) FERTILIZER OR PLANT GROWTH ENHANCER USING LIPID AND OPTIONALLY A CARBOHYDRATE TO INCREASE PLANT YIELD AND METHOD OF INCREASING PLANT YIELD

(71) Applicant: Innovations for World Nutrition, LLC, Florence, AL (US)

(72) Inventors: Arthur R. Shirley, JR., Florence, AL (US); Melissa C. Hayes, Florence, AL (US)

(21) Appl. No.: 17/227,730

(22) Filed: Apr. 12, 2021

Related U.S. Application Data
(60) Provisional application No. 63/010,095, filed on Apr. 15, 2020.

(51) Int. Cl. C05C 9/00

(52) U.S. Cl. CPC C05C 9/00

(57) ABSTRACT

A fertilizer having a source of nitrogen and a lipid, and optionally a carbohydrate. A plant growth enhancer having a lipid and optionally a carbohydrate. A method of increasing plant crop yield and protein levels in the plant product by applying a source of nitrogen and a lipid, and optionally a carbohydrate to soil containing the plant. A method of increasing plant crop yield and protein levels in the plant product by applying a lipid, and optionally a carbohydrate to soil containing the plant.

### FIELD OF THE INVENTION

The invention relates to a fertilizer comprising a lipid, a source of nitrogen and optionally a source of carbohydrate, and a method of growing plants using the fertilizer. The invention further relates to a plant growth enhancer comprising a lipid and optionally a source of carbohydrate, and a method of growing plants using the plant growth enhancer.

### BACKGROUND OF THE INVENTION

Due to rising populations around the world and limited arable land for growing food, finding ways to improve food production is a serious concern. It is well known that plants need nitrogen, phosphorus, potassium, micronutrients, water and carbon dioxide to grow. Of the three major nutrients: nitrogen, phosphorus, and potassium; nitrogen is needed at the highest level to promote optimal growth. For example according to Subbaiah, et al, a N:P₂O₅:K₂O ratio of 4:2:1 is recommended for growing rice {Subbaiah, S. V., et al. “Studies on yield maximization through balanced nutrient ratios in irrigated lowland rice.” International Rice Commission Newsletter (FAO), 50 (2001): 59-65}. However, the carbon required by plants such as a rice plant and its grain is much higher than its need for nitrogen, phosphorus, or potassium. The required nitrogen is typically higher than for phosphorus, potassium, and other nutrients. Measurements of 46 w/w % or more carbon and only 1.3 w/w % nitrogen are common for rough rice (the whole rice grain with the hull). These carbon and nitrogen values result in a carbon:nitrogen (C:N) ratio for rough rice of 35:1. This high C:N ratio illustrates that the amount of carbon needed to promote plant growth and yield dramatically outweighs all of the other nutrients.

It is typically accepted that plants obtain carbon from carbon dioxide from the surrounding air taken in through the stomata in their leaves. However, the amount of carbon dioxide in air is extremely low (currently about 355 ppm). Carbon is a limiting nutrient in plant growth, and thus finding other ways to supply carbon dioxide and carbon to plants have been investigated for years. It is well known that supplying gaseous CO₂ to plant leaves increases yield and is a common practice for greenhouse horticulture.

When a plant seed first sprouts, the only nutrients and energy available for growth are stored in the seed. Initially, the roots form and then the leaves. The leaves of the small seedling have very little surface area, and photosynthesis is limited to the amount of energy the leaves can accept as well as carbon available to build new plant cells. If a plant is stimulated to produce early roots, it gives the plant a head start that allows it to more efficiently take up nutrients including carbon that can be at the roots. The present invention stimulates the growth of plant roots early in their development by providing carbon. The present invention also supplies plant roots with additional uptake-available carbon and energy-rich carbohydrates to promote rapid growth that helps to overcome the low surface area of early leaves and therefore further increases plant growth.

Carbohydrates have been shown to promote plant growth. Sugars from carbohydrates feed organisms in the soil as well as feed plants directly.

Now, with the present invention a new fertilizer and plant growth enhancer have been developed to supply energy and nutrients including carbon to the roots of plants. The invention is effective in growing all types of plants. The plants can be grown in soil or hydroponically. Preferred agricultural crops, include corn, wheat, rice, soybeans, and cotton, to name a few.

Without being bound by any theory, the inventors believe the invention enhances root growth of plants and provides energy to plants and soil microbes that benefit plants.

### SUMMARY OF THE INVENTION

An objective is to provide a novel fertilizer and/or plant growth enhancer for increasing plant root growth and plant crop yield.

The invention includes a fertilizer used to produce increased yields in crops, produce increased plant root growth, improve efficiency of nitrogen uptake by the plant, and increase plant uptake of carbon in crops. The present invention provides a source of nitrogen to plants along with a lipid selected from the group of fatty acids, the salts of a fatty acids, animal fat, plant fat or oil, or a combination of any of these; and a source of carbohydrate selected from the group comprising seed grind, starch, or sugar or a combination.

The source of carbohydrate of the invention provides more than just carbohydrate by using seed grind. Seed grind is the powdery ground grain (seed) of a plant and within this grain is everything that a young plant needs for early growth including carbohydrates, nitrogen, as well as other plant nutrients, secondary nutrients, and micronutrients. The seed grind used in the invention may also include the ground coating of the grain or hull of the grain that also contains nutrients beneficial for plant growth. Preferably, the seed grind is formed from the same type of plant to be grown. For example, for rice, a preferred seed grind is rough rice seed grind. Seed grind can include other ingredients such as one or more of the group comprising additional plant parts, dirt and/or other contaminants, molds, fungi, dispersing agents, parting agents, binders, bacteria, herbicides, pesticides, fungicides, and/or stabilizers, and/or other contaminants or additives. This seed grind does not require the use of seed that has been cleaned to levels for human consumption. These ingredients may make the seed grind unfit for human consumption but the seed grind would still be useful as a fertilizer and/or plant growth promoter.

An alternative invention is a plant growth enhancer used to produce increased yields in crops, produce increased plant root growth, improve efficiency of nitrogen uptake by the plant, improve nitrogen levels in plant products, and increase plant uptake of carbon in crops. The inventive plant growth enhancer is comprised of a lipid selected from the group of fatty acids, the salts of a fatty acids, animal fat, plant fat, vegetable oil such as corn, olive, canola, soybean, peanut, castor, or a combination; and a source of carbohydrate selected from the group comprising seed grind, starch, or sugar or a combination.

An alternative inventive fertilizer can be comprised of fertilizer, lipid and seed grind.

The invention can be in solid, semi-solid, or liquid form as desired for the particular application and/or plant. The plant can be grown in soil or hydroponically.

The inventive fertilizer includes a source of nitrogen from sources such as urea, ammonium bicarbonate, ammonium sulfate, ammonium nitrate, monoammonium phosphate (MAP), diammonium phosphate (DAP), urea ammonium nitrate (UAN), or a combination of these nitrogen sources.

The invention includes a lipid selected from the group of fatty acids such as stearic acid, oleic acid, palmitic acid, arachidic acid, erucic acid, arachidonic acid, linoleic acid, linolenic acid; or salts of a fatty acid such as sodium stearate, magnesium stearate, calcium stearate, potassium stearate, sodium oleate, magnesium oleate, calcium oleate, potassium oleate, sodium palmate, potassium palmate, magnesium palmate, calcium palmate, as a few examples; animal fats; a plant fat or vegetable oils such as corn, olive, canola, soybean, peanut, or castor; or a combination of any of these.

The invention includes a source of carbohydrate selected from a group of seed grind such as one or more of rice seed grind, wheat seed grind, or corn seed grind, for example; a starch such as one or more of corn starch, tapioca starch, rice starch, potato starch, cassava starch, or vegetable starch for example; or a sugar source such as one or more of sucrose, glucose, fructose, agave, fruit, sugar beet, cane syrup, or corn syrup for example; or a combination of any of these.

The present invention is free of components unsuitable for use to grow plants. Hence, the invention is free of components harmful to humans or animals such as lithium and heavy metals. For this invention free means that the levels meet the limits set by government for land application and that the levels are below accepted levels that are shown to cause harm to humans or animals consuming the crop.

If soil tests show the soil to be deficient in one or more nutrients, then a starter fertilizer that contains a small amount of nitrogen with other primary nutrients, secondary nutrients, and micronutrients at the levels indicated by soil tests can be applied. The starter fertilizer can be applied at, before, or just after planting and prior to the application of the invention. Alternatively, the starter fertilizer can be applied with or as part of the invention. This starter fertilizer can also include other nutrients or micronutrients that may be needed for the crop based on the results of soil testing.

The invention can be applied as a solid, liquid, suspension, or slurry. The invention is preferably applied as a granule, tablet, or supergranule (very large granule made by rotary pellet machines in the same manner as range cubes). The invention works for all plants and ideally works for crops such as rice, wild rice (genus: Zizania), sugar cane, water chestnuts, lotus, taro, water spinach, watercress, water celery, arrowroot, sago palm, nipa palm, marsh-type or fen grasses such as Saccharum hybrids, and other biomass crops such as bald cypress, eucalyptus, corn, cotton, soybeans, wheat, cassava, sugar beets, energy grasses such as Miscanthus, Pennisetum purpureum, Switchgrass, and other prairie grasses.

The inventive fertilizer and/or plant growth promoter can produce increased plant growth for all types of plants including but not limited to trees, bushes, ornamental plants, vegetables, fruits, vines, and more regardless of whether the plants are grown from seeds, rhizomes, tubers, roots, grafts, or any other method of starting plants. The inventive fertilizer and/or plant growth promoter can be especially beneficial to seedling that are transplanted. For example, the invention can shorten the time for transplanted seedling to reach maturity after transplanting.

Thus, the present invention includes methods of applying the present invention, including a double application of fertilizers, i.e., the application of a starter fertilizer followed by the application of the invention, or applying the starter fertilizer and invention together. The invention may also be applied in multiple applications instead of a single application.

Without being bound by any theory, the inventors believe that using a seed grind formed from ground up seeds increases the available seed ingredients used to grow the initial roots from a seed, which greatly enhances the initial root growth. The early growth of roots is far more beneficial then enhancement of plant growth later in the growing cycle. For example, plants having enhanced early root growth stay ahead of other plants not having enhanced early root growth throughout the entire growing season. Preferably, the seed grind is formed from the same type of seed to be grown. For example, for growing rice, ground up rice seeds (seed grind) is preferably used to enhance the early growth of roots from the seed. However, other types of seed grind (non-rice seeds) can be used as an enhancer for rice. For example, rice seed grind has been found to be effective at enhancing the early growth of roots from cotton seeds.

The source of carbohydrate of the invention can be any seed grind. However, the seed grind contains more than just a carbohydrate. As discussed previously, the seed grind provides other seed ingredients required to grow the initial roots. Thus, another embodiment of the invention is the use of seed grind to grow initial roots from seed.

### BRIEF DESCRIPTION OF THE FIGURES

FIG. 1—Annotated photograph of cups showing root growth.

### DETAILED DESCRIPTION OF THE INVENTION

It is well documented by agronomists that when a plant has a head start, it is always a healthier and more productive plant. A set of tests discussed in Example 2 was performed using a unique approach to observe early root growth without damaging the plants. This was accomplished by planting the seeds in cups of soil where the cup was transparent. This transparent cup was then placed inside an opaque cup. The seeds were planted in the soil against the inside surface of the transparent cup so that the roots could be checked simply by pulling the transparent cup out of the opaque cup and then replacing it when finished with the observation. The opaque cup protected the roots from light during growth. The roots were viewed without disturbing the plants as they were developing and therefore a view of the early growth of the roots was possible. Seeing the early roots revealed how quickly they developed and allowed them to be compared with the baseline roots and thereby showed the extreme benefits of the early application of the invention even before significant plant leaves were formed. These observations and the crop yields obtained later for the plants that were transplanted from the cups demonstrated that early improved root development for the invention resulted in increased plant growth and increased crop yield. Even early in the plant growth, the improvements in the roots of the plants receiving the inventive plant growth enhancer were dramatically evident to the observer. This was because the plant's need for carbon and energy was supplied before the leaves of the plants could provide them.

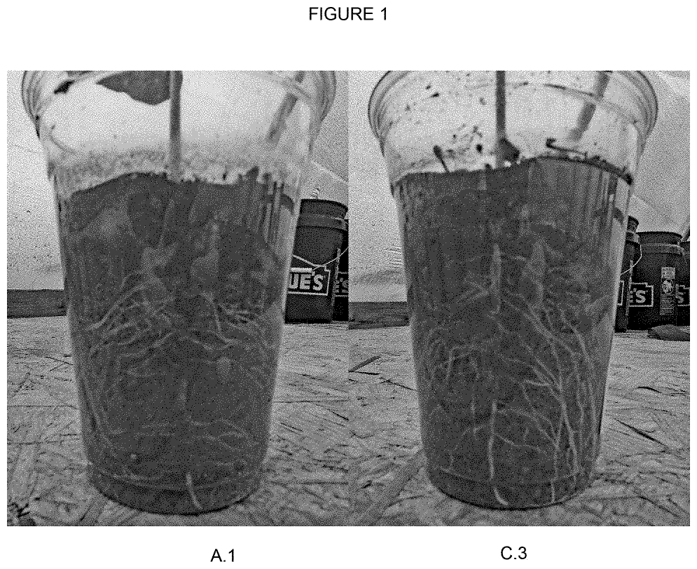

FIG. 1 shows a comparison of the root growth for Example 2 between a baseline cotton plant (A.1) and a cotton plant that received the inventive plant growth enhancer (C.3). As can be seen from FIG. 1, the roots are dramatically improved for the plant that received the plant growth enhancer.

The source of carbohydrate of the invention can be a seed grind. However, the seed grind contains more than just a carbohydrate. As discussed previously, the seed grind provides other seed ingredients required to grow initial roots of a plant. Thus, another embodiment of the invention comprises a lipid and a seed grind to grow the initial roots.

Seed grind contains many benefits for plants. For example, Table 1 shows a comparison of energy and nutrients of various seeds, according to USDA Nutrient Database (https://fdc.nal.usda.gov/).

TABLE 1
Nutritional Value per 100 g

| | Brown | | White | | Whole | | Corn Meal | | Corn |
|---|---|---|---|---|---|---|---|---|---|
| | Rice | | Rice | | Wheat | | (Corn Seed Grind) | | Starch |
| Energy | 370 | kcal | 370 | kcal | 332 | kcal | 361 | kcal | 375 kcal |
| Carbohydrates | 77.24 | g | 81.68 | g | 74.48 | g | 76.85 | g | 87.5 |
| Sugars | 0.85 | g | Not | | 1.02 | g | 0.64 | g | 0 |
| | | | reported | | | | | | |
| Dietary Fiber | 3.52 | g | 2.8 | | 13.1 | g | 7.3 | g | 0 |
| Fat | 2.92 | g | 0.55 | g | 1.95 | g | 3.86 | g | 0 |
| Protein | 7.82 | g | 6.81 | g | 9.61 | g | 6.93 | g | 0 |
| Calcium | 23 | mg | 11 | mg | 33 | mg | 7 | mg | 0 |
| Iron | 1.47 | mg | 1.6 | mg | 3.71 | g | 2.38 | mg | 0 |
| Magnesium | 143 | mg | 23 | mg | 117 | g | 93 | mg | 0 |
| Phosphorus | 333 | mg | 71 | mg | 323 | mg | 272 | mg | 0 |
| Potassium | 223 | mg | 77 | mg | 394 | mg | 315 | mg | 0 |
| Selenium | 23.4 | μg | 15.1 | μg | 12.7 | μg | 15.4 | μg | 0 |
| Sodium | 7 | mg | 7 | mg | 3 | mg | 5 | mg | 0 |
| Zinc | 2.02 | mg | 1.2 | mg | 2.96 | mg | 1.73 | mg | 0 |

Brown rice also contains many vitamins. As can be seen from Table 1, brown rice contains energy including carbohydrates and sugars as well as nutrients that are beneficial to plant growth. Brown rice seed grind contains more than white rice seed grind. Similarly, corn meal (corn seed grind) contains nutrients not found in corn starch.

Thus, seed grind including the whole seed provides more benefit to the growth of plants than seed grind that includes only seed without the hull, coating, and/or bran. Thus, a preferred seed grind of the invention includes seed grind comprising one or more of the group of rough rice seed grind, brown rice seed grind, whole wheat seed grind, wheat seed grind that includes the hull, corn seed grind, and/or other whole grains and/or whole grains with hulls.

A particle size range of a seed grind can be preferably 95% of the particles by weight between 44 micrometers (325 ISO sieve designation) and 2.00 mm (10 ISO sieve designation) or preferably 90% of the particle by weight between 63 micrometers (230 ISO sieve designation) and 2.00 mm (10 ISO sieve designation). We believe that seed grinds having a higher percentage of larger particle sizes will have a slower release of benefits to a plant over time and that seed grinds having a higher percentage of lower particles sizes will have a faster release of benefits to a plant over time. Thus, the size of the seed grind can be adjusted for the particular application as desired.

Based on the chemical formula for corn starch, the percent carbon present in corn starch is 46.8%. According to Xue, the carbon in rice grain is 53-64% (Xue, W-ei, “Evaluation of biophysical factors driving temporal variations in carbon gain, water use and yield production in rice,” Thesis, Lanzhou University, January 2015).

For this description, improved nitrogen efficiency means that nitrogen loss from the fertilizer to the atmosphere and leaching is reduced; that nitrogen supplied by the fertilizer is available to the plant for a longer period of time; and that the plant takes up more nitrogen than is supplied by the invention. Improved carbon uptake efficiency means that plants are able to utilize available carbon sources in the invention, soil, and atmosphere more than plants grown under similar conditions given fertilizers supplying the same levels of primary nutrients (nitrogen, phosphorus, and potassium), secondary nutrients (sulfur, calcium, and magnesium), and the same level of micronutrients such as zinc, boron, iron, copper, manganese, molybdenum, and selenium. The plant utilization of carbon is measured as increased root mass, increased foliage mass, and when present, increased yield of plant product, such as for example grain.

For this description, crop yield refers to the weight of plant product per unit growing area, wherein the plant product is the part of the plant that is valuable as a commercial product, such as grain for example. Crop yield is typically expressed as kg/hectare, tonnes/hectare, bushels/acre, or pounds/acre depending on the type of crop grown.

For this description, early in the plant growth means before the plant foliage weight reaches 10% of the plant foliage weight at harvest or in the first 30 days of plant growth when grown from a seed.

The invention is preferably applied as a granule or tablet near the seed or plant roots early in the plant's growth. An alternative form of the invention is as a package granule. The package granule comprises a water permeable, water soluble, or biodegradable outside layer containing within the components of the invention. The contained components can be in the form of a solid, liquid, suspension, or slurry. When the package granule encounters water, soil moisture, or biodegrades, the components start dissolving or dispersing to form a region around the package having a higher concentration of components compared to the components found in other areas of the soil. This higher concentration of components around the package granule slows the solubility or dispersion of the contents of the package granule.

At planting and prior to or with the application of the present inventive fertilizer, a starter fertilizer can be applied to the soil days before, at, or shortly after planting. This starter fertilizer contains preferably up to 56.1 kg/hectare (50 pounds/acre), more preferably 16.8-50.5 kg/hectare (15-45 pounds/acre), and most preferably 22.4-33.6 kg/hectare (20-30 pounds/acre) of starter nitrogen in the form of a nitrogen fertilizer such as urea, ammonium nitrate, ammonium sulfate, potassium nitrate, mono ammonium phosphate (MAP), diammonium phosphate (DAP), urea-ammonium nitrate (UAN), or ammonium bicarbonate. In addition, the starter fertilizer can include other nutrients and micronutrients recommended based on the crop being grown and the soil test results on the soil used to grow the crop. Other nutrients in the starter fertilizer recommended based on soil testing can include phosphorus from fertilizers such as MAP, DAP, triple super phosphate or super phosphate; potassium from fertilizers such as potassium chloride and potassium sulfate; sulfur from elemental sulfur and a variety of sulfate fertilizers; or micronutrients such as magnesium, calcium, zinc, boron, manganese, iron, or more.

The starter fertilizer can comprise one or more of the following nutrients:

1) nitrogen compounds selected from but not limited to the group consisting of urea, ammonia, ammonium nitrate, ammonium sulfate, calcium nitrate, sodium nitrate, diammonium phosphate (DAP), monoammonium phosphate (MAP), potassium nitrate, ammonium bicarbonate, or urea ammonium nitrate (UAN).

2) phosphorous compounds selected from but not limited to the group consisting of triple super phosphate, super phosphate, diammonium phosphate, monoammonium phosphate, monopotassium phosphate, dipotassium phosphate, tetrapotassium pyrophosphate, or potassium metaphosphate.

3) potassium compounds selected from but not limited to the group consisting of potassium chloride, potassium nitrate, potassium sulfate, monopotassium phosphate, dipotassium phosphate, tetrapotassium pyrophosphate, or potassium metaphosphate.

4) secondary nutrients, and micronutrients sources selected from but not limited to the group consisting of elemental sulfur, calcium carbonate (limestone), calcium oxide, calcium nitrate, dolomite, gypsum, shell, marl, iron sulfate, iron oxides, chelated iron, iron nitrate, zinc sulfate, zinc oxide, chelated zinc, zinc-oxysulfate, zinc carbonate, copper oxide, copper sulfate, copper nitrate, magnesium nitrate, magnesium sulfate, magnesium oxide, magnesium carbonate, selenium sulfate and selenium oxide, sodium tetraborate decahydrate (borax), sodium tetraborate pentahydrate, sodium tetraborate-pentaborate, colemanite, boric acid, ammonium molybdate, sodium molybdate, molybdic oxide, or manganese sulfate.

5) liquid nutrient sources selected from but not limited to the group consisting of urea-ammonium nitrate (UAN), ammonia, bio slurries, or other slurries or suspensions.

6) organic nutrient sources selected from but not limited to the group consisting of manures, animal litters, or others.

Unless otherwise stated in this description, all percent amounts are weight percent based on the total weight of the composition.

The a source of nitrogen in the inventive fertilizer is comprised preferably of urea but can include other sources of nitrogen such as ammonium sulfate, ammonium nitrate, potassium nitrate, monoammonium phosphate diammoniumum phosphate, or urea ammonium nitrate, to name a few. The urea employed in the inventive fertilizer can be substituted or supplemented with compounds selected from but not limited to the group consisting of ureaform, urea formaldehyde, methylene urea, methylene diurea or dimethylenetriurea.

For the components of the invention, all of the % compositions are calculated as weight percent of the total composition on a dry basis; or in other words, they are calculated as a percent of the total weight without added water. Thus, for suspensions, slurries and dispersions, the amount of the active ingredients can be determined before adding water and non-active ingredients such as fillers.

The source of nitrogen of the fertilizer is preferably 40%-99% and more preferably 60% to 98%; the lipid is preferably 0.5%-30%, more preferably 1%-20%, and most preferably 2%-15%; and the source of carbohydrate, when present is preferably from 0.5% up to 30%, more preferably 1% up to 20%, and most preferably 2% up to 15%.

The inventive plant growth enhancer is comprised of preferably 30% up to 99% lipid and preferably 1% up to 70% source of carbohydrate.

A preferred embodiment of the invention comprises urea, magnesium stearate, rice seed grind and sugar.

In one preferred embodiment of the invention, the lipid is applied at a rate of 2.2 kg/hectare (2 pounds/acre) to 28 kg/hectare (25 pounds/acre), more preferably 2.2 kg/hectare (2 pounds/acre) to 16.8 kg/hectare (15 pounds/acre) and most preferably 2.2 kg/hectare (2 pounds/acre) to 8.4 kg/hectare (7.5 pounds/acre).

In a preferred embodiment of the plant growth enhancer, the lipid is 33% of the invention; and the source of carbohydrate is 67% of the invention.

In a preferred embodiment, the invention is placed beneath the soil surface within about 10 cm (4 inches) of the seed or seedling just before, at, or just after planting.

The inventive fertilizer and plant growth enhancer each can be formed separately into granules, tablets, package granules or supergranules optionally using bio-degradable binders, lubricants, glidants, and antiadherents. These binders, lubricants, glidants, and antiadherents include up to 10% stearic acid, up to 10% magnesium stearate, and up to 10% corn starch. A preferable amount of binders, lubricants, glidants, and antiadherents, would be up to 5% stearic acid, up to 5% magnesium stearate, and up to 5% corn starch; and the most preferable amount is 0.2%-1.5% stearic acid, 0.2%-1.5% magnesium stearate, and 0.2%-1.5% corn starch. Some other possible binders include sugars such as corn syrup, maltodextrin, sucrose, lactose, and glucose; starches like tapioca starch; gums like gelatin; synthetic polymers like polyvinylpyrrolidone (PVP), polyethylene glycol (PEG); cellulose and cellulose derivatives like methylcellulose and ethylcellulose; and waxes including paraffin wax, beeswax, palm wax, and soy bean wax. Some other possible lubricants, glidants, and anitadherents include but are not limited to talc, corn starch, colloidal silica, boric acid, magnesium lauryl sulfate glyceryl palmitostearate, glyceryl behenate.

The invention can be placed beneath the soil 1.3-25.4 cm (0.5-10 inches) deep and more preferably 5.1-12.7 cm (2-5 inches) deep early in the plant's growth. Alternatively, the invention may be applied to the surface of the soil and mechanically incorporated into the soil or moved into the soil with water. Ideally, the depth is chosen to make the invention available in the root zone of the plant early in the plant growth. When planting a seedling, the invention can be placed at the time of planting.

As shown in the following examples, rice grown with the invention shows unexpected and significant improvement in total nitrogen utilization and total carbon uptake by plants. Because of the increased carbon utilization in rice, the invention is a form of carbon sink or recycler for lowering carbon dioxide in the atmosphere.

When used to grow rice, the invention provides an unexpected increase in crop yield of 25% or more, an increase in carbon uptake of 10%-100% or more, and an increase in nitrogen uptake of 10%-100% or more.

When used to grow cotton, the invention provides an unexpected increase in crop yield of up to 50% or more, an increase in carbon uptake of 10%-100% or more, and an increase in nitrogen uptake of 10%-100% or more.

When used to grow cotton, supplying magnesium stearate with brown rice seed grind and powdered sugar as a plant growth enhancer produced a 33% increase in crop yield and this increase in crop yield was more for plants supplied with either magnesium stearate alone or brown rice seed grind alone.

An effective method of the invention includes the following: 1) Performing soil tests to identify primary nutrient, secondary nutrient, and micronutrient deficiencies; 2) Applying starter nutrients to the soil early in the crop growth at the levels recommended for the crop being grown and based on the expected crop yield per acre and the soil test results; 3) Applying the inventive fertilizer or plant growth enhancer to the soil early in the crop growth before, at, with, or after applying the starter nutrients by burying the fertilizer or plant growth enhancer, side applying the fertilizer or plant growth enhancer, mechanically incorporating the fertilizer or plant growth enhancer, broadcasting the fertilizer or plant growth enhancer, injecting the fertilizer or plant growth enhancer, spraying the fertilizer or plant growth enhancer, or any combination of these at the levels recommended for the crop being grown and based on the expected crop yield per acre and the soil test results.

While only a few exemplary embodiments of this invention have been described in detail, those skilled in the art will recognize that there are many possible variations and modifications which can be made in the exemplary embodiments while yet retaining many of the novel and advantageous features of this invention. Accordingly, it is intended that the following claims cover all such modifications and variations.

### EXAMPLES

### Example 1: Magnesium Stearate and Stearic Acid with Fertilizer

Rice was grown for Example 1 Tests in containers with a surface area of 929 cm² (0.79 ft²) in a climate controlled greenhouse with 20 kg of soil in each container. This soil was mixed and sieved prior to filling the containers. Soil analyses for the soil used for these tests were performed by the University of Arkansas on three soil samples. The results of the soil analyses are presented in Table 1.

TABLE 1
Soil Analyses

| | | mg/kg (weighed) | | | | | | | | | |
|---|---|---|---|---|---|---|---|---|---|---|---|
| I.D. | pH | P | K | Ca | Mg | S | Na | Fe | Mn | Zn | Cu |
| R9.1 | 5.9 | 7.6 | 50.2 | 792 | 61 | 34.1 | 6.3 | 83 | 141 | 0.95 | 0.34 |
| R9.2 | 5.8 | 7.6 | 50.3 | 775 | 61 | 34.2 | 6.6 | 84 | 141 | 0.97 | 0.38 |
| R9.3 | 5.8 | 7.9 | 49.6 | 807 | 63 | 31.4 | 7.1 | 83 | 147 | 1.05 | 0.37 |

| | |
|---|---|
| mg/kg | wt % |

| I.D. | pH | B | % N | % C |
|---|---|---|---|---|
| R9.1 | 5.9 | 0.25 | 0.0617 | 0.6294 |
| R9.2 | 5.8 | 0.25 | 0.0596 | 0.5819 |
| R9.3 | 5.8 | 0.25 | 0.0605 | 0.5954 |

Starter nutrients were added to the soil in each of the containers. The starter nutrients per container were 3.58 g of triple super phosphate, 0.50 g urea, 2.76 g KCl, 1.04 g ZnSO₄.7H₂O, 16.6 g MgSO₄.7H₂O, 0.0165 g boric acid, and 0.220 g CuSO₄.5H₂O. The triple super phosphate was mixed into the top 7.62-10.16 cm (3-4 inches) of soil first and then the rest of the starter nutrients were made into a solution of the concentration needed so that 200 mL of solution contained the amount listed above. 200 mL of this solution was then poured evenly over the soil surface of each container. Next the top 7.62-10.16 cm (3-4 inches) of soil was mixed and the rice seed was then planted.

To plant the rice seed, 10-15 seeds per container were placed on the surface of the soil. The seed was then pushed beneath the soil surface approximately 1.91 cm (¾ inch) deep and the hole was filled with sand. Finally, the surface was watered as needed with the same measured amounts of water for all buckets to maintain normal moisture levels in the buckets.

After the rice plants emerged and reached the 4-leaf stage, the rice was thinned to five plants per bucket. The soil was then flooded with water until the water maintained a level 0.64 to 1.27 cm (¼ to ½ inch) above the soil surface. Next the inventive fertilizer or baseline fertilizer was placed in the center of each bucket 7.62-10.16 cm (3-4 inches) deep as discussed below.

After the fertilizer was placed, the water level in the containers was gradually increased to 5.08 to 7.62 cm (2 to 3 inches) above the soil surface and then maintained at the level through the growth of the rice.

Two methods of fertilizer application were used and are referred to in Table 3. The first is denoted as SG which is a supergranule made by compressing the ingredients together. The supergranules used for the test were nearly spherical and 1.91 cm (0.75 inches) in diameter. The second application method is denoted as PG which is a package granule made by placing the fertilizer components in a water permeable package that was tied together at the top. This removed the possibility of wax encapsulating the powders and providing slow release benefits. Each PG or SG contained the ingredients at the levels for the corresponding test formulation shown in Table 3.

TABLE 2
Fertilizer Formulations for Example 1 Tests

| | 1-1 | 1-2 | 1-3 |
|---|---|---|---|
| Compound | Weight in Formulation (g) | | |
| Urea | 25.50 | 25.50 | 25.50 |
| Paraffin Wax | 18.10 | 18.10 | 18.10 |
| Magnesium Stearate | 0.00 | 0.00 | 1.40 |
| Stearic Acid | 0.00 | 0.00 | 1.40 |
| Total Weight (g) | 43.60 | 43.60 | 46.40 |
| Weight per Bucket (g) | 4.36 | 4.36 | 4.64 |

TABLE 3
Average Yields for Example 1 Tests

| Test | | Method of | Avg. Dry | Max. Dry | % Difference |
|---|---|---|---|---|---|
| Label | Formulation | Application | Yield (g) | Yield (g) | in Yield |
| 1-1 | Urea with no | PG | 77.1 | 97.1 | +3.7% |
| | stearates | | | | |
| 1-2 | Urea with no | SG | 74.4 | 93.6 | Baseline |
| | stearates | | | | |
| 1-3 | Urea with | PG | 83.8 | 109.5 | 17.0% |
| | stearates | | | | |

The following conclusions can be drawn from the experimental data:

Applying a fertilizer that contained urea, stearic acid, and magnesium stearate provided a 17% increase in crop yield over fertilizing with urea alone.

Our understanding of the invention and other work with fertilizer showed that the wax is not important for producing an increase in crop yield. Hence, the composition of the invention without the wax providing a 17% increase in crop yield is comprised of 90.2% urea, 4.9% magnesium stearate, and 4.9% stearic acid.

### Example 2

For Example 2 tests, cotton seeds were planted in transparent cups using sieved topsoil from the local area. Each cup contained 400 g of soil mixed with 0.125 g of super phosphate, and the top surface of the soil was about 10.2 cm (4 inches) in diameter.

The cups holding the soil were transparent plastic and were placed inside opaque cups. The seeds were planted in the soil against the surface of the transparent cups and the outer opaque cups protected the roots from light during growth. By removing the inner cups, the roots were viewed and pictures taken daily without disturbing the plants as they were developing and therefore a view of the early growth of the roots was possible. Seeing the early roots allowed us to see how quickly they developed and allowed them to be compared with the baseline roots showing the extreme benefits of the early application of the invention even before significant plant leaves were formed. These observations and crop yields obtained later demonstrated that early improved root development for the invention resulted in increased plant growth and increased crop yield.

Formulations were mixed to add to the cups at planting. These formulations were labeled as shown below:

A—Baseline receiving only regular fertilizer

B—magnesium stearate—each cup was given 0.1 g (MS).

C—0.1 g magnesium stearate+0.1 g brown rice seed grind+0.1 g powdered sugar per cup (MS+SG+PS).

D—brown rice seed grind—each cup was given 0.2 g which is the same weight of carbohydrate as was given to C (SG).

The formulations were placed in the center of the cup in a hole that was 3.8 cm (1.5 inches) deep and then covered with soil. After the formulations were placed in the cups, all of the cups were given a starter fertilizer. This starter fertilizer was given to each cup as 25 mL of a solution that contained 0.2 g urea, 0.2 g KCl, and 1.0 g Epson salt. Two cotton seeds were planted in each container 1.9 cm (¾ inch) deep and 7.62 cm (3 inches) apart. The transparent cups had drainage holes in them. The seeds were planted in the cups on May 5, 2019. The cups were thinned to one plant per cup after the plants emerged.

On Jun. 6, 2019, the cotton plants in the cups were transplanted into large containers of 20 kg of sieved local top soil. Before transplanting, 2.0 g of triple super phosphate was mixed into the top 7.62-10.16 cm (3-4 inches) of top soil. Each bucket was also given 200 mL of solution containing 0.28 g urea and 0.63 g Epson Salt. The plants were gently removed from the cups to disturb the roots and surrounding soil as little as possible and planted with one plant in the center of each container.

Soil tests for the top soil used in the containers are shown in Table 4.

TABLE 4
Soil Analysis results for the top soil used
to transplant the cotton for Example 2

| | | ppm | | | | | | | | | | |
|---|---|---|---|---|---|---|---|---|---|---|---|---|
| Label | pH | P | K | Ca | Mg | B | Na | Fe | Mn | Zn | Cu | Al |
| S1 | 7.2 | <0.1 | 51 | 3558 | 135 | 0.2 | 41 | 16 | 29 | 1 | 1 | 200 |
| S2 | 6.5 | <0.1 | 43 | 3716 | 132 | 0.2 | 42 | 14 | 28 | 1 | 1 | 202 |

Soil Analyses, cont.

| | Wt. % | | |
|---|---|---|---|
| | % S | % N | % C |
| S1 | | | |
| S2 | | 0.0617 | 0.6294 |

Based on the soil test results, additional nutrients were added to the containers in solution form on Jun. 20, 2019. Each container was given 500 mL of a solution that contained 33.4 g Epson salt, 2.0 g KCl, 0.70 g ZnSO₄.H₂O, 0.50 g Boric Acid per 500 mL. Each container was also given 1.73 g of monoammonium phosphate as a solution.

The total dry weight of the cotton bolls with seeds were measured for each container and the results are shown in Table 5.

TABLE 5
Total Dry Weight of Cotton Bolls for Example 2.

| | Total | Average | % Difference | |
|---|---|---|---|---|
| | Dry Weight | Weight | of Average | |
| Label | of Bolls (g) | of Bolls (g) | from Baseline | Formulation |
| A.1 | 47.9 | 52.3 | 0.0% | Baseline |
| A.2 | 72.9 | | | |
| A.3 | 40.2 | | | |
| B.2 | 63.4 | 63.4 | 21.2% | MS |
| C.2 | 59.9 | 69.8 | 33.3% | MS + |
| C.3 | 79.6 | | | SG + PS |
| D.2 | 65.6 | 56.7 | 8.4% | SG |
| D.3 | 47.8 | | | |

As can be seen from Table 5, supplying magnesium stearate with brown rice seed grind and powdered sugar as a plant growth enhancer produced the greatest increase in crop yield (+33%) and this increase in crop yield was more than for plants supplied with either magnesium stearate alone or rice seed grind alone.

1. A fertilizer comprising:
a source of nitrogen; and
a lipid, wherein the fertilizer provides increased plant crop yield, increased plant root growth, improved efficiency of nitrogen uptake by the plant, improved nitrogen levels in the plant, and increased plant uptake of carbon.

2. The fertilizer according to claim 1, further comprising a source of carbohydrate.

3. The fertilizer according to claim 1, wherein the lipid is selected from the group of fatty acids, the salts of a fatty acids, animal fat, plant fat or oil, or a combination of any of these.

4. The fertilizer according to claim 1, wherein the lipid is selected from the group stearic acid, oleic acid, palmitic acid, arachidic acid, erucic acid, arachidonic acid, linoleic acid, linolenic acid, sodium magnesium stearate, calcium stearate, potassium stearate, sodium oleate, magnesium oleate, calcium oleate, potassium oleate, sodium palmate, potassium palmate, magnesium palmate, calcium palmate, or a combination of any of these.

5. The fertilizer according to claim 2, wherein the source of carbohydrate comprises at least one of seed grind, starch, or sugar.

6. The fertilizer according to claim 2, wherein the source of carbohydrate comprises brown rice seed grind.

7. The fertilizer according to claim 1, wherein the source of nitrogen comprises at least one of urea, ammonium bicarbonate, ammonium sulfate, ammonium nitrate, monoammonium phosphate (MAP), diammonium phosphate (DAP), or urea ammonium nitrate (UAN).

8. The fertilizer according to claim 1, wherein the a source of nitrogen is 40%-99% by weight and the lipid is 0.5%-30% by weight.

9. A plant growth enhancer comprising a lipid, wherein the plant growth enhancer provides increased plant crop yield, increased plant root growth, improved efficiency of nitrogen uptake by the plant, improve nitrogen levels in the plant, and increased plant uptake of carbon.

10. The plant growth enhancer according to claim 9, further comprising a source of carbohydrate.

11. The plant growth enhancer according to claim 9, wherein the lipid is selected from the group of fatty acids, the salts of a fatty acids, animal fat, plant fat or oil, or a combination of any of these.

12. The plant growth enhancer according to claim 9, wherein the lipid is selected from the group of stearic acid, oleic acid, palmitic acid, arachidic acid, erucic acid, arachidonic acid, linoleic acid, linolenic acid, sodium stearate, magnesium stearate, calcium stearate, potassium stearate, sodium oleate, magnesium oleate, calcium oleate, potassium oleate, sodium palmate, potassium palmate, magnesium palmate, or calcium palmate, or a combination of any of these.

13. The plant growth enhancer according to claim 10, wherein the source of carbohydrate comprises at least one of seed grind, starch, or sugar.

14. The plant growth enhancer according to claim 10, wherein the source of carbohydrate comprises brown rice seed grind.

15. The plant growth enhancer according to claim 10, further comprising 50%-99% by weight of the lipid and 1% up to 50% the carbohydrate.

16. A method of increasing plant crop yield and increasing protein levels in the plant product comprising the following steps:
applying a lipid to soil containing the plant; and
applying a source of nitrogen to the soil.

17. The method according to claim 16, further comprising applying a source of carbohydrate to the soil.

18. The method according to claim 16, further comprising testing soil to check for amounts of nutrients, secondary nutrients, and micronutrients;
applying a first fertilizer to the soil or water surface of flooded soil, in which is growing cultivated plants.

19. The method according to claim 16, further comprising enhancing the growth of rice.

20. The method according to claim 17, further comprising using brown rice seed grind as the source of carbohydrate.

21. The method according to claim 16, wherein the plant is a seed or seedling.

22. The method according to claim 16, further comprising applying the fertilizer beneath the soil from about 0.5 to about 10 inches deep to apply the growth enhancer to roots of the plant.

23. The method according to claim 22, wherein the fertilizer is moved under the soil by use of water or mechanical incorporation.

24. The method according to claim 16, further comprising conducting a second application of the fertilizer two weeks or more after the first application.

25. The method according to claim 16, wherein the fertilizer is in solid, semi-solid, or liquid form.

26. The method according to claim 17, wherein the source of carbohydrate comprises at least one of seed grind, starch, or sugar.

27. The method according to claim 17, wherein the source of carbohydrate is seed grind formed from a same type of plant to be grown.

28. The method according to claim 17, wherein the source of carbohydrate comprises brown rice seed grind.

29. The method according to claim 16, wherein the source of nitrogen is 40%-99% by weight and the lipid is 0.5%-30% by weight.

30. A method of increasing plant crop yield and increasing protein levels in plant product comprising the following steps:
applying a lipid to soil containing the plant.

31. The method according to claim 30, further comprising applying a source of carbohydrate to the soil.

32. The method according to claim 30, further comprising testing soil to check for amounts of nutrients, secondary nutrients, and micronutrients;
applying a first fertilizer to the soil or water surface of flooded soil, in which is growing cultivated plants.

33. The method according to claim 30, further comprising enhancing the growth of rice.

34. The method according to claim 31, further comprising using brown rice seed grind as the source of carbohydrate.

35. The method according to claim 30, wherein the plant is a seed or seedling.

36. The method according to claim 30, further comprising applying the plant growth enhancer beneath the soil from about 0.5 to about 10 inches deep to apply the growth enhancer to roots of the plant.

37. The method according to claim 36, wherein the plant growth enhancer is moved under the soil by use of water or mechanical incorporation.

38. The method according to claim 30, further comprising conducting a second application of the plant growth enhancer two weeks or more after the first application.

39. The method according to claim 31, wherein the source of carbohydrate comprises at least one of seed grind, starch, or sugar.

40. The method according to claim 31, wherein the source of carbohydrate comprises brown rice seed grind.
